(19) United States
(12) Patent Application Publication
(10) Pub. No.: US 2001/0019924 A1
(43) Pub. Date: Sep. 6, 2001

(54) Contact socket

(76) Inventor: Hans Jost Heimueller, Dudenhofen (DE)

Correspondence Address: Tyco Technology Resources, 4550 New Linden Hill Road, Suite 450, Wilmington, DE, 19808, US

(21) Appl. No.: 09/773,198

(22) Filed: Jan. 31, 2001

(30) Foreign Application Priority Data
Jan. 31, 2000 (EP) 00101876.1

(51) Int. Cl. H01R 11/22; H01R 13/11

(52) U.S. Cl. 439/851

(57) ABSTRACT

A contact socket formed of two parts, an engagement sleeve and a contact spring, which is enclosed in a chamber-like manner by the engagement sleeve and the contact spring is provided through a support spring resulting in support between a contact location of contact spring and a holding section of contact spring.

### BACKGROUND OF THE INVENTION

The present invention relates to a contact socket.

### DESCRIPTION OF THE PRIOR ART

The known contact sockets have a complicated construction and are therefore difficult to manufacture. These known contact sockets are also expensive to manufacture. It is therefore an object of the present invention to provide a contact socket allowing the design of a simpler manufacturing process and which thereby entails lower costs.

### SUMMARY OF THE INVENTION

This object is achieved by a contact socket having an engagement sleeve enclosing, in a chamber-like manner, a contact spring, where the contact spring includes at least one spring leg, characterized in that the contact spring is supported via at least one lateral support spring, whereby the support spring is formed integrally on the contact spring.

Accordingly, the contact socket which is formed in two parts, comprises an engagement sleeve and a contact spring which is enclosed in a chamber-like manner by the engagement sleeve.

The two-part construction allows the material for the engagement sleeve and the contact spring to be separately provided and worked. The manufacturing process and materials can be optimized and adapted to the individual component.

Further advantageous developments of the contact socket according to the invention are the subject of the dependent claims.

### BRIEF DESCRIPTION OF THE DRAWINGS

FIG. 1 shows a schematic cross-sectional view of a contact socket according to the invention in accordance with a first preferred embodiment of the present invention;

FIG. 2 shows a further cross-sectional view of the contact socket according to FIG. 1;

FIG. 3 shows a layout of an engagement sleeve of the contact socket according to FIGS. 1 and 2;

FIG. 4 shows a layout of a contact spring of the contact socket according to FIGS. 1 and 2;

FIG. 5 shows a schematic cross-sectional view of a contact socket according to the invention, in accordance with a second preferred embodiment of the present invention;

FIG. 6 shows a further cross-sectional view of the contact socket according to FIG. 5;

FIG. 7 shows a layout of an engagement sleeve of the contact socket according to FIGS. 5 and 6; and

FIG. 8 shows a layout of a contact spring of the contact socket according to FIGS. 5 and 6.

### DETAILED DESCRIPTION OF THE PREFERRED EMBODIMENT

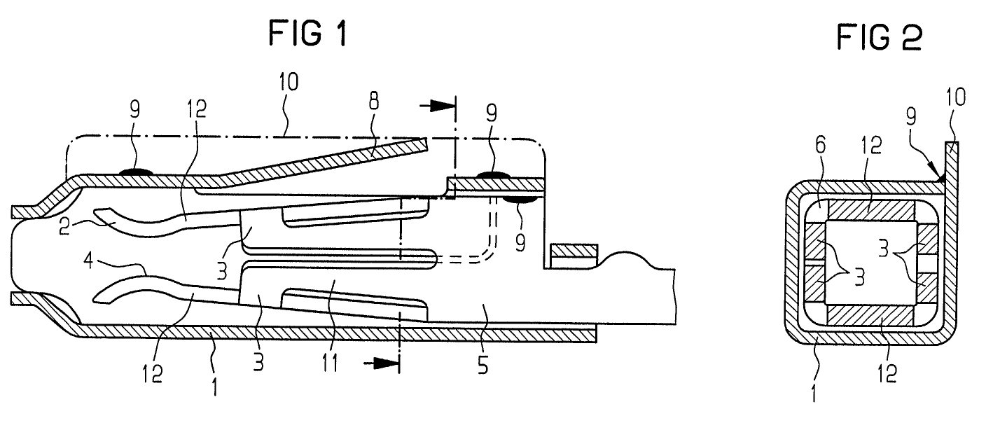

In FIGS. 1 and 2 there is shown a contact socket according to the invention, in accordance with a first embodiment, where, in a lateral cross-sectional view, the chamber-like closing of contact spring 2 by an engagement sleeve 1 can be easily recognized.

According to this first embodiment, two support springs 3 are each formed on the contact spring 2 in the lateral region, approximately between a front contact location 4 and a rear holding section 5, to support the two free ends of the contact spring 2 and situated opposite to the contact locations 4.

According to the view of FIG. 1, each support spring 3 is shown as being essentially U-shaped, whereby a very wide base 11 is foreseen. Each base 11 extends substantially parallel to contact spring 2 and is attached thereto by two short connecting legs which extend from the end of base 11 in the direction of contact spring 2.

As can be seen from FIG. 2, the contact spring 2 is formed with a substantially square cross-section and is completely enclosed by the generally square engagement sleeve 1 in both the contact region and in the support region.

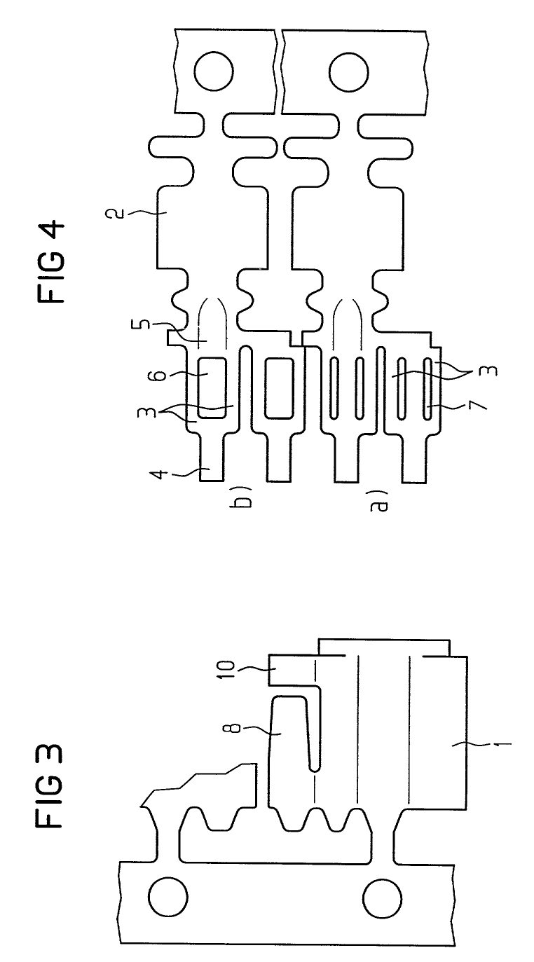

The attaching point of the lateral support springs 3 on the contact spring 2 lies between contact location 4 and the holding section 5, such that a maximum spring displacement is maintained and the non-supported part of the spring legs 12 of contact spring 2 is not quite yet overloaded by the contact force upon an inserted contact pin (not shown). This construction has the advantage that maximum spring displacement is obtained while providing an optimum support of the spring legs 12 by the support springs 3. FIG. 3 shows the layout of the engagement sleeve 1 and the contact spring 2, whereby the contact spring 2 is represented in two alternative designs (a) and (b). These representations are not to scale. The layout of the engagement sleeve 1 comprises a latching tongue 8 which, during bending of the engagement sleeve 1, while protruding outwardly, is bent upwards in order to allow an anchorage of the engagement sleeve 1 in a receiving chamber (not shown) of a plug. In addition, a projection 10 is foreseen which is bent away from the engagement sleeve 1, approximately at a right angle, as can be seen from FIG. 2, in order to form a polarization of the contact socket.

The contours of the layouts of the engagement sleeves 1 and contact springs 2 are preferably stamped out of flat metal sheets as shown in FIGS. 3 and 4. After the stamping operation, the individual engagement sleeves 1 and contact springs 2 are separated and bent. The contact spring 2 is first bent into shape and the pre-bent or pre-folded engagement sleeve 1 is subsequently bent around the contact spring 2 such that the state as shown in FIGS. 1 and 2 is finally created.

The engagement sleeve 1 and/or the contact spring 2 are preferably laser soldered such that a solder pad 9 (from the top direction of the tool) is formed on several locations.

The two alternative designs (a) and (b) according to FIG. 4 differ mainly by the size of the recess 6 or 7 on the contact spring 2, whereby the flexural strength of the spring leg 12 is increased by means of a smaller recess 7.

The construction of the contact socket according to the invention, in particular through the cooperation of spring leg 12 and support spring 3 on the contact spring 12, the spring leg 12 is guided away from the inner wall of the engagement sleeve 1 relatively far back, in the direction of the holding section 5 (or terminal section), whereby an improved spring action of the spring leg 12 can be achieved. The required support of the spring legs 12 is obtained through support springs 3.

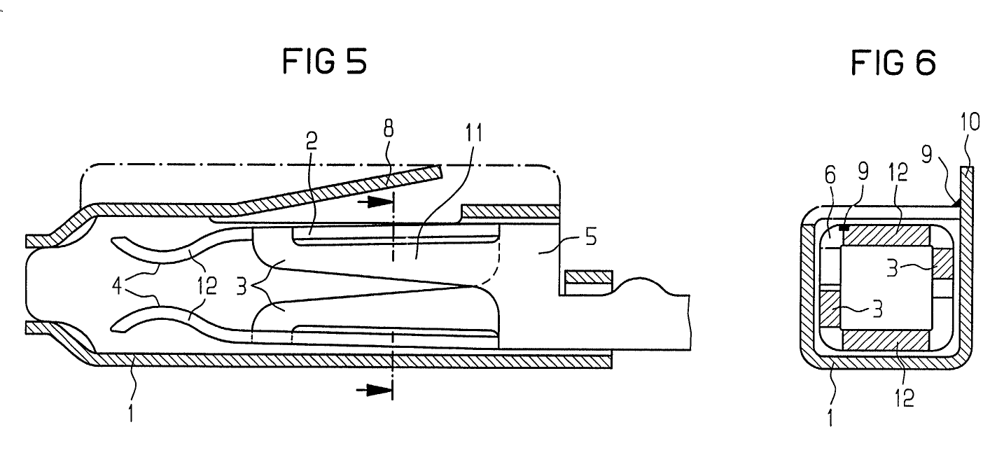

FIGS. 5 to 8 show a second embodiment of the present contact socket. The effect and function obtained correspond to the first embodiment. However, the lateral support springs 3 on each side are formed as single springs, as can be seen from FIG. 5 and 6. he advantage obtained in this way is simpler stamping and bending operations. There is the disadvantage that, in comparison with the first embodiment, a minor rotation (reduced torsion stiffness) of the spring legs 12 under load is more likely to occur.

FIGS. 5 and 6 show the contact socket according to the invention in accordance with the second embodiment, whereby a lateral cross-sectional view of the chamber-like enclosure of a contact spring 2 by an engagement sleeve 1 is shown here. According to this second embodiment, one support spring 2 per side is formed on the contact spring 4 in the lateral region, approximately between a front contact location 4 and a rear holding section 5, to support the two free ends (spring legs 12) of contact spring 2 having opposite contact locations 4.

According to the view of FIG. 5, each support spring 3 is shown as being essentially U-shaped, where a very wide base 11 is foreseen, which extends substantially parallel to contact spring 2, as well as one short connecting leg each at the front end (left in FIG. 5) which extends from the front end of base 11 in the direction of contact spring 2. In the rear section of base 11 the support spring 3 extends into the holding section 5.

As shown in FIG. 6, the contact spring 2 is formed with a substantially square cross-section and is completely enclosed by the equally generally square engagement sleeve 1 in the contact region and in the support region.

The attaching point for the lateral support springs 3 on the contact spring 2 lies between contact location 4 and the holding section 5, such that a maximum spring displacement is maintained and the non-supported part of the spring legs 12 of contact spring 2 is not quite yet overloaded by the contact force (of an inserted contact pin which is not shown). This construction has the advantage that a maximum spring displacement is obtained while providing an optimum support of the spring legs 12 by the support springs 3.

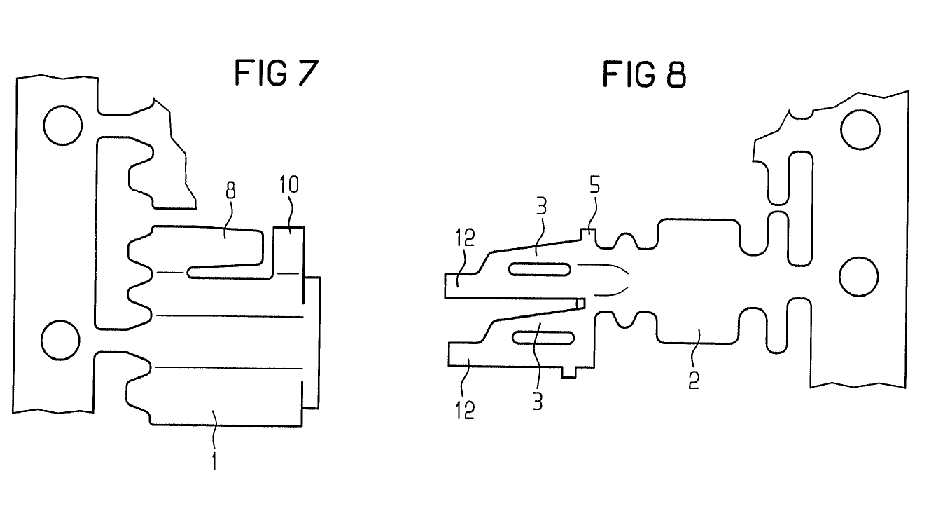

FIGS. 7 and 8 show the layout of the engagement sleeve 1 and the contact spring 2. These representations are not to scale. The layout of the engagement sleeve 1 comprises a latching tongue 8 which, during bending of the engagement sleeve 1, while protruding outwardly, is bent upwards in order to allow an anchorage of the engagement sleeve 1 in a receiving chamber (not shown) of a plug. In addition, a projection 10 is foreseen which is bent away from the engagement sleeve 1 approximately at a right angle, as is shown in FIG. 2, in order to form a polarization of the contact socket.

The contours of the layouts of the engagement sleeves 1 and contact springs 2 are preferably stamped out of flat metal sheet, as shown in FIGS. 7 and 8. After the stamping operation, the individual engagement sleeves 1 and contact springs 2 are separated and bent. The contact spring 2 is first bent into shape and then the pre-bent or pre-folded engagement sleeve 1 is subsequently bent around the contact spring 2 such that the state as shown in FIGS. 5 and 6 is finally created. The engagement sleeve 1 and/or the contact spring 2 are preferably laser soldered such that a solder pad 9 (from the top direction of the tool) is formed on several locations.

The construction of the contact socket according to the invention, in particular through a cooperation of spring leg 12 and support spring 3 on the contact spring 2, allows the spring leg 12 to be guided away from the inner wall of the engagement sleeve 1 relatively far back, in the direction of the holding section 5 (or terminal section), whereby an improved spring action of the spring leg 12 can be achieved. The required support of the spring legs 12 is obtained through support springs 3.

For the engagement sleeve, spring steel material, such as X12CrNi, is used, while for the contact spring a copper beryllium spring or a steel spring provided with a precious metal plating is used.

In summary, the contact socket according to the invention, which is formed in two parts, comprises an engagement sleeve 1 and a contact spring 2 which is enclosed in a chamber-like manner by the engagement sleeve 1. The two-part construction allows the material for the engagement sleeve 1 and the contact spring 2 to be separately provided and worked. The manufacturing process can be optimized and adapted to the individual component. The contact spring 2 is furthermore provided with a support spring 3 which results in a support between a contact location 4 of the contact spring 2 and a holding section 5 of the contact spring 2. For further characteristics and advantages of the present invention, specific reference is hereby made to the appended claims and drawings.

I/we claim:

1. A contact socket, comprising an engagement sleeve enclosing, in a chamber-like manner, a contact spring, where the contact spring includes at least one spring leg, characterized in that the contact spring is supported via at least one lateral support spring, whereby the support spring is formed integrally on the contact spring.

2. The contact socket according to claim 1, characterized in that the support spring is formed on each side of the contact spring.

3. The contact socket according to claim 1, characterized in that the engagement sleeve is made of spring steel.

4. The contact socket according to claim 1, characterized in that the contact spring comprises a precious metal plating at least in the region of one contact location.

5. The contact socket according to claim 1, characterized in that the contact spring is beryllium copper.

6. The contact socket according to claim 1, characterized in that the support spring supports the contact spring between the contact location and a holding section.

7. The contact socket according to claim 1, characterized in that a recess is formed between a base part of the contact spring and the support spring.

8. The contact socket according to claim 1, characterized in that the engagement sleeve and the contact spring have a substantially square crosssection.

9. The contact socket according to claim 8, characterized in that the engagement sleeve and the contact spring are made of a flat metal sheet by stamping and bending.

10. The contact socket according to claim 9, characterized in that the engagement sleeve and/or the bent contact spring are each fixed by laser.

11. The contact socket according to claim 1, characterized in that a polarization is formed on the engagement sleeve in the form of a projection.

12. The contact socket according to claim 1, characterized in that an outwardly protruding, resilient latching tongue is formed on the engagement sleeve.

13. The contact socket according to claim 1, characterized in that each contact spring two oppositely arranged spring legs.
